(19) United States
(12) Patent Application Publication
(10) Pub. No.: US 2004/0015704 A1
(43) Pub. Date: Jan. 22, 2004

(54) Smartchip biometric device

(76) Inventor: Stefaan De Schrijver, Newton, MA (US)

Correspondence Address: LAHIVE & COCKFIELD, 28 STATE STREET, BOSTON, MA, 02109, US

(21) Appl. No.: 10/299,046

(22) Filed: Nov. 18, 2002

Related U.S. Application Data
(63) Continuation of application No. PCT/US01/16055, filed on May 17, 2001.
(60) Provisional application No. 60/205,061, filed on May 18, 2000.

(51) Int. Cl. H04K 1/00

(52) U.S. Cl. 713/186

(57) ABSTRACT

A writing instrument that incorporates a first microprocessor within the writing instrument structure, wherein the first microprocessor incorporates the smart card technology, and is capable of transmitting, receiving, processing, and storing signals and other pertinent data. In one embodiment, the first microprocessor internally stores an encrypted PIN for the writing instrument owner. The writing instrument can also incorporate biometric sensors and a second microprocessor to control the biometric sensors and collect biometric data during a signature event. The internally stored and encrypted PIN can be transferred to other systems with biometric information to provide a dual verification scheme. In another embodiment, data stored on the first and/or second microprocessor can be accessed by a reader requiring a PIN input from a user. In another embodiment, a PIN can be written with the writing instrument, and the second microprocessor is subsequently provided biometric data to verify the PIN stored in the first microprocessor and authenticate the user biometric data. The chip information may be displayed on an optional display incorporated into the writing instrument, or on a remote display.

### RELATED INFORMATION

The present application is a continuation of PCT patent application number PCT/US01/16055, filed on May 17, 2001, which claims priority to U.S. provisional patent application No. 60/205,061, filed on May 18, 2000, the entire contents both of which are hereby incorporated by reference.

### BACKGROUND OF THE INVENTION

(1) Field of the Invention

The present invention relates generally to portable computing devices, to smart card technology, and more particularly to incorporating smart card technology into a writing implement structure.

(2) Description of the Prior Art

With increasing miniaturization of electronic devices, it is possible to incorporate certain electronic devices and functionality in common, portable structures. One example of such technology is the smartcard, wherein a miniature computer chip is incorporated into a card having similar structure to a credit card. The embedded microprocessor allows storage of personal data including medical records, etc., on the card, that may be accessed only after the card presenter enters a personal identification number into the card-reading system.

Prior art systems disclose a personal digital assistant (PDA) that includes a touch screen or other user interface, authenticates a user with biometric data, and thereafter allows the user to access stored personal and financial information for reading and writing to a smartcard. The prior art system requires a user interface and a card reader for full functionality and access to the smart card information.

There is currently no smartcard technology that incorporates the smartcard chip in a structure other than a credit card structure.

What is needed is an extension of the smartcard technology to another structure for simplified processing.

### SUMMARY OF THE INVENTION

The present invention provides an apparatus that incorporates the microprocessor and chip technology used in smartcards into a writing implement structure. By also configuring the writing instrument with a transmission device, the writing instrument can communicate, either contact or contactless, wired or wireless, to other devices.

Other objects and advantages of the present invention will become more obvious hereinafter in the specification and drawing.

These objects are accomplished with the present invention by a writing instrument that incorporates a first microprocessor on the writing instrument structure, wherein the first microprocessor incorporates the smart card technology, and is capable of transmitting, receiving, processing, and storing signals and other pertinent data. In one embodiment, the first microprocessor internally stores an encrypted PIN for the writing instrument owner. The writing instrument may also incorporate biometric sensors and a second microprocessor to control such biometric sensors and collect biometric data during a signature event. The internally stored and encrypted PIN can be transferred to other systems with biometric information to provide a dual verification scheme. In another embodiment, data stored on the first and/or second microprocessors is accessed by a reader requiring a PIN input from a user. In another embodiment, a PIN is written with the writing instrument, and the second microprocessor is subsequently provided biometric data to verify the PIN stored in the first microprocessor and authenticate the user biometric data. The chip information can be displayed on an optional display incorporated into the writing instrument, or on a remote display. In another embodiment the data in the smartcard chip are secure. The secure data in the the smartcard chip can only be accessed if the measured biometric data match a stored biometric template of the user of the pen. In one embodiment, the biometric template may be stored in the memory of the second processor. In another embodiment, the biometric template may be stored in the smartcard chip in the pen. In another embodiment, multiple biometric templates may be stored in the pen, thus allowing multiple users. In another embodiment, the pen incorporates enough memory to store large amount of data generated by the sensors, and transferred to a docking station, only after authorization through the functions in the smartcard. This authorization may include biometric verification, in or outside the pen.

In another embodiment, a pen-cap incorporates a smartcard reader that can be connected to a computing device, PDA, telephone or other instrument with an embedded processor, capable of transmitting the smartcard data to an application system. The smartcard reader can be incorporated in a terminal as known in the art, but the invention allows the terminal to perform biometric registration functions and generation of biometric templates for a plurality of users. These templates are then stored in the pen as described above.

Thus the invention allows the incorporation of a contact or contactless smartcard in a pen. The invention further allows the smartcard data to be accessible only after biometric means recognize the user of the pen. The invention further allows this recognition to occur solely in the pen. The invention allows biometric registration in the pen, or in a pen-docking station that functions as smartcard reader. The docking station can have the form of a pen-cap, a pen-holder or any wallet, connectable to a computer by known means.

### BRIEF DESCRIPTION OF THE DRAWINGS

A more complete understanding of the invention and many of the attendant advantages thereto will be readily appreciated as the same becomes better understood by reference to the following detailed description when considered in conjunction with the accompanying drawing, wherein like reference numerals refer to like parts and wherein:

FIG. 1 presents an architectural diagram of an embodiment wherein the smart chip and biometric information provide dual security.

### DESCRIPTION OF THE ILLUSTRATED EMBODIMENTS

To provide an overall understanding of the invention, certain illustrative embodiments will now be described; however, it will be understood by one of ordinary skill in the art that the systems described herein can be adapted and modified to provide systems for other suitable applications and that other additions and modifications can be made to the invention without departing from the scope hereof.

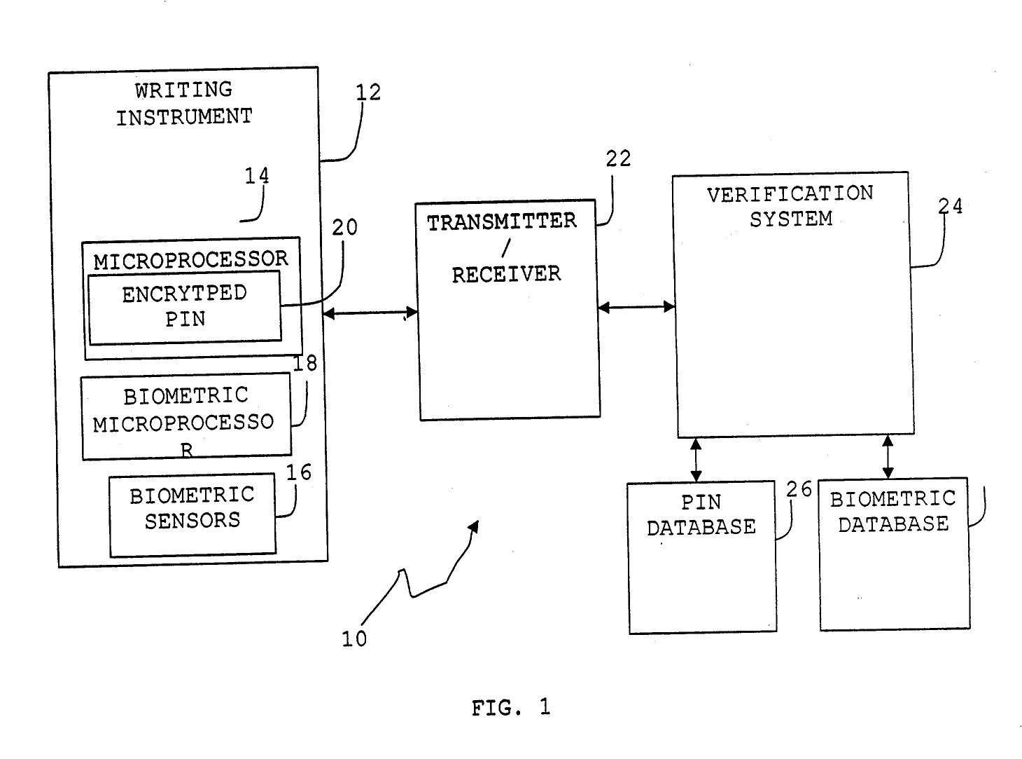

Referring now to FIG. 1, there is shown a diagram of the system architecture 10 for an embodiment wherein a writing instrument structure 12 includes a first microprocessor 14, and the writing instrument 12 can be additionally configured with biometric sensors 16 and a second microprocessor 18 to control the biometric sensors. The FIG. 1 writing instrument 12 includes a pen, but may likewise comprise a pencil, marker, stylus, or other writing instrument capable of generating communicative text. For an embodiment according to FIG. 1, it is not necessary that the writing instrument 12 operate on paper, display, or other surface, providing that the writing instrument 12 provides communicative text to an object or device.

As FIG. 1 indicates, in the illustrated embodiment, the first microprocessor 14 can be embedded in the outer-structure of the writing implement. The first microprocessor can include any microprocessor element capable of being incorporated into the writing implement structure, while allowing for data storage and processing. The first microprocessor can be read and written to electronically by an external device. The first microprocessor can also be programmed for protected data storage.

In an embodiment, the first microprocessor can incorporate the technology known as smart card technology, and can allow a personal identification number (PIN) 20 to be stored electronically within the first microprocessor. The PIN 20 can be stored with some type of encryption or scrambling.

In addition to the first microprocessor 14, the writing instrument can include at least one biometric sensor 16 to record biometric data from the writing instrument user. Such biometric data can be collected during a writing event such as a signature. Examples of biometric information for this embodiment can include writing angles, signature duration, and the forces applied during a signature event, although the invention herein is not limited to the types of biometric data collected. The biometric sensors can be controlled by a second, biometric microprocessor 18, however other embodiments can utilize single microprocessor for the control of the biometric sensors and the writing instrument.

In one embodiment, the first microprocessor related to the smart card technology 14 and the biometric microprocessor 18 function independently. Referring to FIG. 1, in such a configuration, the microprocessors independently interact with a transmitter/receiver 22 that can include a stand-alone system or a system connected to a network. A requirement of the transmitter/receiver 22 includes an ability to interact with the two microprocessors 14, 18 and the verification system 24. The transfer between the writing instrument 12 and the transmitter/receiver 20 can be through contact, such as by connecting an electronically equipped writing instrument cap with a receiver/transmitter for the writing instrument. Alternately, a writing instrument case can be instrumented to transmit and/or receive information from the writing instrument microprocessors 14, 18 to another system.

In an alternate embodiment, the writing instrument may include the transmitter/receiver 20. In yet another embodiment, the first microprocessor 14 can be controlled by the second microprocessor 18, thereby requiring only the second microprocessor 18 to communicate with the transmitter/receiver 20.

In an embodiment according to FIG. 1, the writing instrument microprocessors 14, 18 can provide the encrypted PIN and the biometric information to the verification system 24. The PIN and biometric information can provide dual security measures for user identification and authorization. Particular users can be listed in a database that stores respective PINs and biometric data, or the PIN database 26 and biometric database 28 can be distinct for added security, as shown in FIG. 1. User identification can be authenticated only upon receiving the encrypted PIN and the corresponding validated biometric information for the particular user. The verification results can be transmitted back to the transmitter/receiver 20, or if the writing instrument 12 is equipped with a display, a display can indicate the verification status.

The connections between the writing instrument 12 and the transmitter/receiver 20 can be wired or wireless, and can be through contact or without contact. The transmitter/receiver 20 can be a stand-alone system or a networked system. Similarly, the connections between the transmitter/receiver 20 and the verification system 22 can have the same flexibility without departing from the invention herein.

Depending upon the application and the desire for wired or wireless communications, etc., one practiced in the art may design the transmitter/receiver 20 to be a mobile or stationary telephone, a laptop, palm, desktop, handheld, or networked computer, or any other microprocesser-based electronic device, including but not limited to personal digital assistants, etc., capable of transmitting and receiving information as stored in the microprocessors 14, 18 according to the invention herein, all without departing from the scope of the invention.

In an alternate embodiment wherein the second microprocessor 18 can control the first microprocessor 14, the PIN can again be stored in the first microprocessor 14, but the user may be required to write the PIN with the biometric writing instrument, whereupon the second microprocessor 18 processes the biometric data collected during the PIN writing event to verify the PIN as stored in the first microprocessor 14. The biometric data collected during the PIN writing event, or during a subsequent writing event, can be utilized for dual security.

In another embodiment, the transmitter/receiver 20 can be enabled upon the entry of a personal identification number (PIN). Upon the user entering the correct PIN, the user can extract the otherwise protected data from the writing instrument first microprocessor 14 and transfer the data to an external device, or transfer data from the external device to the first microprocessor 14. By reading the protected data, the external device can authenticate the user (e.g., extract a credit card number). Alternately, depending upon the application, the transmitter/receiver 20 can extract personal information (e.g., medical records) for display on a device including the transmitter/receiver 20, or other such device.

In yet another embodiment, the writing instrument includes a display to display the first microprocessor contents. This application may be most relevant to storing and recalling personal information on the microprocessor such as credit card numbers, telephone numbers, etc., wherein such examples are merely illustrative and the invention herein is not so limited.

What has thus been described is a writing instrument that incorporates a first microprocessor within the writing instrument structure, wherein the first microprocessor incorporates the smart card technology, and is capable of transmitting, receiving, processing, and storing signals and other pertinent data. In one embodiment, the first microprocessor internally stores an encrypted PIN for the writing instrument owner. The writing instrument can also incorporate biometric sensors and a second microprocessor to control such biometric sensors and collect biometric data during a signature event. The internally stored and encrypted PIN can be transferred to other systems with biometric information to provide a dual verification scheme. In another embodiment, data stored on the first and/or second microprocessors can be accessed by a reader requiring a PIN input from a user. In another embodiment, a PIN can be written with the writing instrument, and the second microprocessor is subsequently provided biometric data to verify the PIN stored in the first microprocessor and authenticate the user biometric data. The chip information can be displayed on an optional display incorporated into the writing instrument, or on a remote display.

Although the present invention has been described relative to a specific embodiment thereof, it is not so limited. Obviously many modifications and variations of the present invention may become apparent in light of the above teachings. For example, the communications between the microprocessors embedded in the writing instrument, and the verification system, may be wired or wireless, and may utilize any standard, well-known communications technique or protocol. The verification system may be any microprocessor controlled device. Similarly, the verification device may incorporate the PIN and biometric databases.

Many additional changes in the details, materials, steps and arrangement of parts, herein described and illustrated to explain the nature of the invention, may be made by those skilled in the art within the principle and scope of the invention. Accordingly, it will be understood that the invention is not to be limited to the embodiments disclosed herein, may be practiced otherwise than specifically described, and is to be understood from the following claims, that are to be interpreted as broadly as allowed under the law.

What is claimed is:

1. A writing instrument comprising:
an outer surface constructed and arranged to be gripped by a user, the outer surface further comprising a microprocessor.

2. The writing instrument of claim 1, wherein the microprocessor can at least one of transmit data, receive data, store data, and process data.

3. The writing instrument of claim 1, wherein the microprocessor is activated by an electronic device, through contact or contactless means.

4. The writing instrument of claim 1, further comprising at least one biometric sensor.

5. The writing instrument of claim 1, further comprising:
at least one biometric sensor;
a distinct second microprocessor to control the biometric sensors;
a biometric signature data memory;
a registration module to register pen users and to generate biometric templates used in verification;
a verification module to process data from the at least one biometric sensor and compare the biometric data to the biometric signature data memory; and,
an activation module to activate the electronic module based upon the verification module output.

6. The writing instrument of claim 1, further comprising a display.

7. The writing instrument of claim 1, wherein the microprocessor further comprises a display driver to display the data.

8. The writing instrument of claim 1, wherein the element for engaging a writing media comprises a stylus tip.

9. The writing instrument of claim 1, wherein the element for engaging a writing media comprises an ink cartridge tip.

10. The writing instrument of claim 1, wherein the element for engaging a writing media comprises a lead pencil.

11. The writing instrument of claim 7, further comprising a software user interface to display the data.

12. A method for securing data using biometric data, comprising,
collecting the biometric data;
collecting a personal identification number (PIN); and,
providing access to the data based upon validation of the biometric data and the PIN.

13. A method according to claim 12, wherein collecting the biometric data further comprises collecting information from a signature event.

14. A method according to claim 12, wherein collecting a PIN further includes collecting the PIN from a signature event.

15. A method according to claim 12, wherein providing access to the data based on validation of the biometric data further comprises comparing the collected biometric data to a biometric database.

16. A method according to claim 12, wherein,
collecting PIN further includes collecting a PIN using a first microprocessor; and,
collecting biometric data further includes collecting biometric data using a distinct second microprocessor.
